(19) United States
(12) Patent Application Publication
(10) Pub. No.: US 2023/0385660 A1
(43) Pub. Date: Nov. 30, 2023

(54) APPARATUS AND METHOD FOR EVALUATING PERFORMANCE OF DEVICE AND STORAGE MEDIUM

(71) Applicant: MITSUBISHI HEAVY INDUSTRIES, LTD., Tokyo (JP)

(72) Inventors: Naoto Omura, Tokyo (JP); Shunsuke Mizumi, Tokyo (JP); Hideki Ono, Tokyo (JP); Shota Mochizuki, Yokohama-shi (JP); Yoshito Nagahama, Yokohama-shi (JP); Nobuhiro Osaki, Yokohama-shi (JP)

(73) Assignee: MITSUBISHI HEAVY INDUSTRIES, LTD., Tokyo (JP)

(21) Appl. No.: 18/034,176

(22) PCT Filed: Aug. 16, 2022
(86) PCT No.: PCT/JP2022/030953

§ 371 Date: Apr. 27, 2023

(30) Foreign Application Priority Data
Sep. 22, 2021 (JP) 2021-153785

(51) Int. Cl. G06N 5/04; G06F 7/58

(52) U.S. Cl. CPC G06N 5/04; G06F 7/588

(57) ABSTRACT

An apparatus for evaluating performance of a device includes: an overall performance function acquisition part configured to obtain an overall performance function which indicates a change over time in performance index of an evaluation target device, based on data acquired during operation of the evaluation target device; an individual performance function definition part configured to define a plurality of individual performance functions each of which indicates a change over time in the performance index caused by a plurality of change factors of the performance index, respectively; and a model generation part configured to generate a performance estimation model for the evaluation target device by performing superposition of the plurality of individual performance functions. The model generation part determines a coefficient of each of the plurality of individual performance functions in the superposition so the superposition of the plurality of individual performance functions becomes close to the overall performance function.

### TECHNICAL FIELD

This disclosure relates to an apparatus, a method, and a program for evaluating the performance of a device.

The present application claims priority based on Japanese Patent Application No. 2021-153785 filed on Sep. 22, 2021, the entire content of which is incorporated herein by reference.

### BACKGROUND ART

In a plant such as power generation plant, predictions of the performance of the plant or devices constituting the plant may be used to manage the operation of the plant and the devices.

Patent document 1 discloses a method for predicting the performance of a power generation plant using a hybrid prediction model that includes a static physics-based model and a corrector model that corrects the prediction by the physics-based model on the basis of data collected from the plant. In the method of Patent Document 1, the corrector model is trained using the latest plant operation data, so that changes in performance due to deterioration of devices, updating of control mechanisms, etc., are reflected in the performance prediction.

### CITATION LIST

### Patent Literature

Patent Document 1: JP2012-079304A

### SUMMARY

### Problems to be Solved

There may be multiple factors involved in performance changes (performance degradation, etc.) of a plant or devices constituting the plant. However, conventional prediction methods cannot estimate the factors of performance changes because they predict performance changes of the plant or devices as a whole.

In view of the above, an object of at least one embodiment of the present invention is to provide an apparatus, a method, and a program for evaluating the performance of a device whereby it is possible to quantitatively estimate changes over time in performance and estimate the factors behind the performance changes for the device to be evaluated.

### Solution to the Problems

An apparatus for evaluating performance of a device according to at least one embodiment of the present invention includes: an overall performance function acquisition part configured to obtain an overall performance function which indicates a change over time in performance index of an evaluation target device, on the basis of data acquired during operation of the evaluation target device; an individual performance function definition part configured to define a plurality of individual performance functions each of which indicates a change over time in the performance index caused by a plurality of change factors of the performance index, respectively; and a model generation part configured to generate a performance estimation model for the evaluation target device by performing superposition of the plurality of individual performance functions. The model generation part is configured to determine a coefficient of each of the plurality of individual performance functions in the superposition so that the superposition of the plurality of individual performance functions becomes close to the overall performance function.

Further, a method for evaluating performance of a device according to at least one embodiment of the present invention includes: a step of obtaining an overall performance function which indicates a change over time in performance index of an evaluation target device, on the basis of data acquired during operation of the evaluation target device; a step of defining a plurality of individual performance functions each of which indicates a change over time in the performance index caused by a plurality of change factors of the performance index, respectively; and a step of generating a performance estimation model for the evaluation target device by performing superposition of the plurality of individual performance functions. The step of generating the performance estimation model includes determining a coefficient of each of the plurality of individual performance functions in the superposition so that the superposition of the plurality of individual performance functions becomes close to the overall performance function.

Further, a program for evaluating performance of a device according to at least one embodiment of the present invention is configured to cause a computer to execute: a process of obtaining an overall performance function which indicates a change over time in performance index of an evaluation target device, on the basis of data acquired during operation of the evaluation target device; a process of defining a plurality of individual performance functions each of which indicates a change over time in the performance index caused by a plurality of change factors of the performance index, respectively; and a process of generating a performance estimation model for the evaluation target device by performing superposition of the plurality of individual performance functions. The process of generating the performance estimation model includes determining a coefficient of each of the plurality of individual performance functions in the superposition so that the superposition of the plurality of individual performance functions becomes close to the overall performance function.

### Advantageous Effects

At least one embodiment of the present invention provides an apparatus, a method, and a program for evaluating the performance of a device whereby it is possible to quantitatively estimate changes over time in performance and estimate the factors behind the performance changes for the device to be evaluated.

### BRIEF DESCRIPTION OF DRAWINGS

FIG. 1 is a schematic diagram of an evaluation target device (turbine) according to some embodiments.

FIG. 2 is a schematic configuration diagram of the performance evaluation apparatus for a device according to an embodiment.

FIG. 3 is a flowchart of the performance estimation method for a device according to an embodiment.

FIG. 4 is a graph showing an example of a change over time in turbine internal efficiency.

FIG. 5 is a graph showing an example of the overall performance function F(t).

FIG. 6 is a graph schematically showing an example of the individual performance function.

FIG. 7 is a diagram schematically showing an example of the first correlation.

FIG. 8 is a diagram schematically showing an example of the second correlation.

FIG. 9 is a diagram for describing how to obtain the second correlation.

FIG. 10 is a diagram for describing how to obtain the second correlation.

FIG. 11 is a schematic graph visually showing an example of the performance estimation model.

FIG. 12 is a schematic graph visually showing an example of the performance estimation model.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

(Configuration of Performance Evaluation Apparatus)

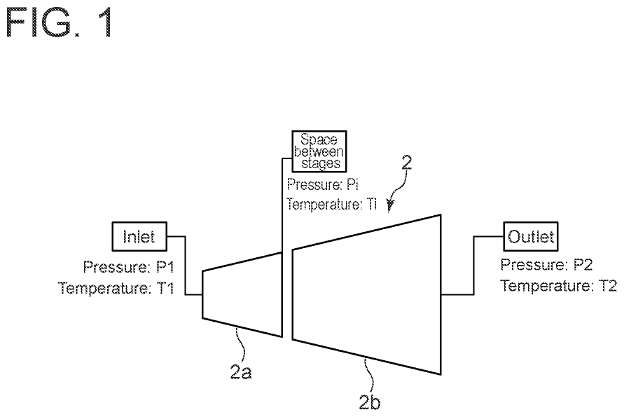

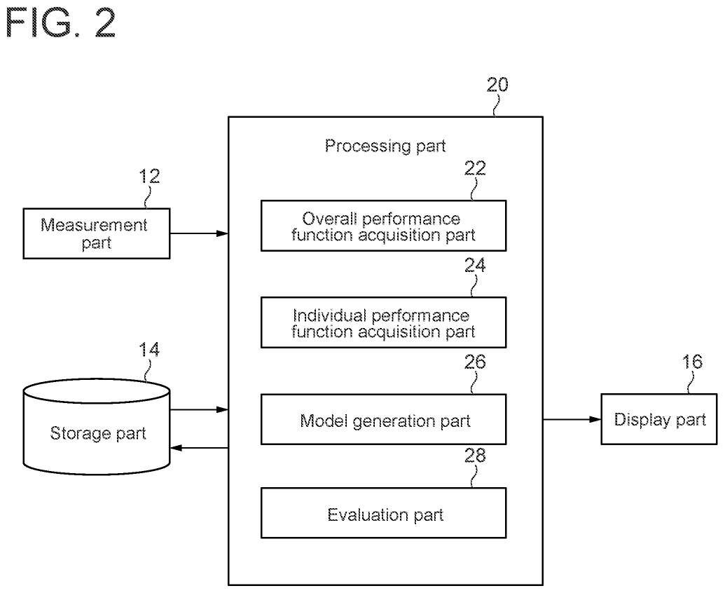

FIG. 1 is a schematic diagram of a turbine 2 which is an example of a device to be evaluated by the performance evaluation apparatus according to some embodiments. FIG. 2 is a schematic configuration diagram of the performance evaluation apparatus for a device according to an embodiment.

A device (evaluation target device) to be evaluated by the performance evaluation apparatus according to some embodiments may be the whole or part of a plant, or devices constituting the plant or some of them.

The turbine 2 shown in FIG. 1 is configured to be driven by a working fluid. The working fluid is introduced into the turbine 2 through a turbine inlet. The working fluid having finished work in the turbine 2 is discharged from the turbine 2 through a turbine outlet. A generator may be connected to the rotational shaft of the turbine 2.

The turbine 2 may be a steam turbine configured to be driven by steam. Alternatively, the turbine 2 may be a gas turbine configured to be driven by gas generated by combustion of fuel.

The turbine 2 shown in FIG. 1 includes multiple stages of turbine blade rows divided into an upstream stage section 2a, which is the upstream section in the flow direction of the working fluid, and a downstream stage section 2b, which is the section downstream of the upstream stage section 2a. In an embodiment, the turbine 2 may be configured to extract the working fluid from a space between the upstream stage section 2a and the downstream stage section 2b.

In an embodiment, a plant including the turbine 2 may be the evaluation target device. In an embodiment, the turbine 2 may be the evaluation target device. In an embodiment, the upstream stage section 2a or the downstream stage section 2b of the turbine 2 may be the evaluation target device.

The performance evaluation apparatus 20 shown in FIG. 2 is configured to process information acquired from a measurement part 12 and/or a storage part 14 and evaluate the performance of the evaluation target device.

The measurement part 12 is configured to measure a parameter related to the performance index of the evaluation target device.

For example, the turbine internal efficiency may be used as the performance index of the turbine 2 which is the evaluation target device. In this case, the measurement part 12 may include a plurality of sensors for measuring the pressure P1 and temperature T1 at the turbine inlet and the pressure P2 and temperature T2 at the turbine outlet. The turbine internal efficiency can be calculated from measured values of these parameters.

When the evaluation target device is the upstream stage section 2a of the turbine 2, the turbine internal efficiency of the upstream stage section 2a may be used as the performance index. In this case, the measurement part 12 may include a plurality of sensors for measuring the pressure P1 and temperature T1 at the turbine inlet and the pressure Pi and temperature Ti between the upstream stage section 2a and the downstream stage section 2b (space between stages).

When the evaluation target device is the downstream stage section 2b of the turbine 2, the turbine internal efficiency of the downstream stage section 2b may be used as the performance index. In this case, the measurement part 12 may include a plurality of sensors for measuring the pressure Pi and temperature Ti between the upstream stage section 2a and the downstream stage section 2b (space between stages) and the pressure P2 and temperature T2 at the turbine outlet.

When the evaluation target device is the entire plant, the generator output or heat consumption rate may be used as the performance index of the evaluation target device.

The performance evaluation apparatus 20 is configured to receive signals indicating measured values of parameters related to the performance index from the measurement part 12. The performance evaluation apparatus 20 may be configured to receive signals indicating measured values from the measurement part 12 at a specified sampling period. The performance evaluation apparatus 20 is configured to process the signals received from the measurement part 12 and evaluate the performance of the evaluation target device. The evaluation result by the performance evaluation apparatus 20 may be displayed on a display part 16 (e.g., display).

As shown in FIG. 2, the performance evaluation apparatus 20 according to an embodiment includes an overall performance function acquisition part 22, an individual performance function definition part 24, a model generation part 26, and an evaluation part 28.

The performance evaluation apparatus 20 includes a calculator equipped with a processor (e.g., CPU), a storage device (memory device; e.g., RAM), an auxiliary storage part, and an interface. The performance evaluation apparatus 20 receives signals indicating measured values of parameters related to the performance index of the evaluation target device from the measurement part 12 via the interface. The processor is configured to process the signals thus received. In addition, the processor is configured to process programs loaded into the storage device. Thereby, the function of the above-described functional units (overall performance functional unit acquisition part 22, etc.) is implemented.

The processing contents in the performance evaluation apparatus 20 may be implemented as programs executed by the processor. The programs may be stored in the auxiliary storage part. When executed, these programs are loaded into the storage device. The processor reads out the programs from the storage device to execute instructions included in the programs.

The overall performance function acquisition part 22 is configured to obtain an overall performance function which indicates a change over time in performance index of the evaluation target device, on the basis of data acquired during operation of the evaluation target device.

The individual performance function definition part 24 is configured to define a plurality of individual performance functions each of which indicates a change over time in performance index caused by a plurality of change factors of the performance index, respectively.

The model generation part 26 is configured to generate a performance estimation model for the evaluation target device by performing superposition of the plurality of individual performance functions defined by the individual performance function definition part 24. Further, the model generation part 26 is configured to determine a coefficient of each of the plurality of individual performance functions in the superposition so that the superposition of the plurality of individual performance functions becomes close to the overall performance function acquired by the overall performance function acquisition part 22.

The evaluation part 28 is configured to estimate a change over time in performance of the evaluation target device on the basis of the performance estimation model generated by the model generation part 26. Alternatively, the evaluation part 28 may be configured to estimate factors of the change over time in performance of the evaluation target device.

(Flow of Performance Evaluation of Device)

Hereinafter, the performance evaluation method for a device according to some embodiments will be described. The following describes the case where the above-described performance evaluation apparatus 20 is used to execute the performance evaluation method for a device according to an embodiment, but in some embodiments, another apparatus may be used to execute the performance evaluation method for a device. In the following, the evaluation target device is the turbine 2. The following describes the case of evaluation of the performance degradation of the evaluation target device.

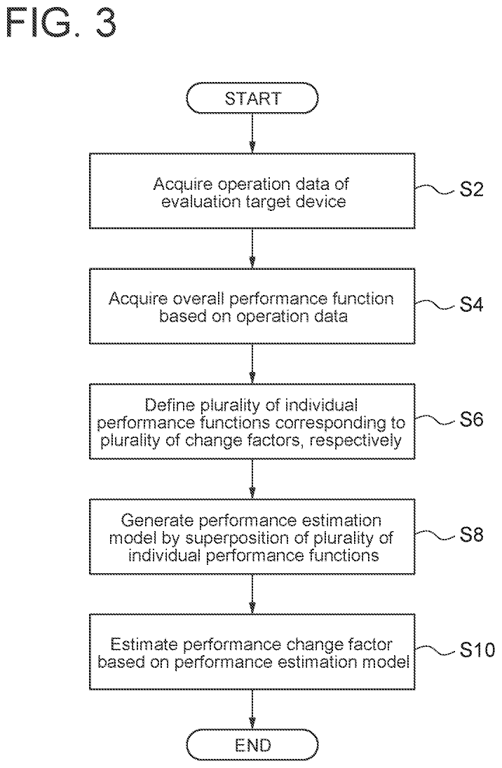

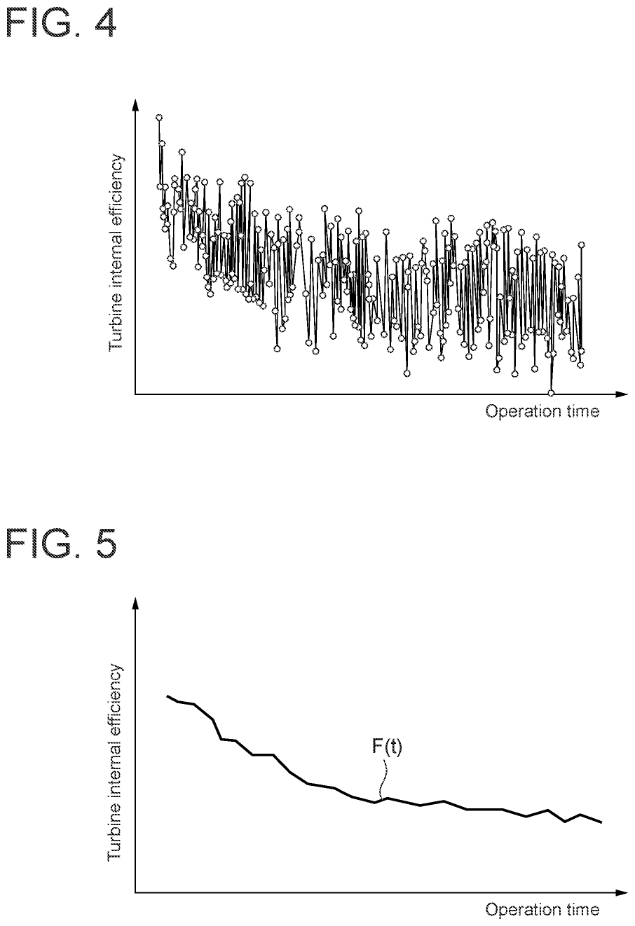

FIG. 3 is a flowchart of the performance estimation method for a device according to some embodiments. FIGS. 4 to 12 are each a diagram for describing the performance estimation method for a device according to some embodiments.

As shown in FIG. 3, in some embodiments, first, data related to the performance index of the turbine 2 to be evaluated is acquired during operation of the turbine 2 (S2).

In step S2, first, the measurement part 12 acquires measurement data of parameters related to the performance index of the turbine 2 (evaluation target device). In this example, the turbine internal efficiency is used as the performance index of the turbine 2, and the measurement data of pressure P1 and temperature T1 at the turbine inlet and pressure P2 and temperature T2 at the turbine outlet are acquired as parameters related to the turbine internal efficiency, respectively. The measured values of these parameters are repeatedly acquired over time.

Then, the turbine internal efficiency as the performance index is calculated based on the measurement data of the parameters. FIG. 4 is a graph showing an example of a change (performance degradation) over time in turbine internal efficiency of the turbine 2 thus obtained. Then, the overall performance function acquisition part 22 obtains an overall performance function which indicates a change over time in turbine internal efficiency (performance index) of the turbine 2 on the basis of the data acquired in step S2. The overall performance function can be obtained by applying a general time-series model to the performance index data (see FIG. 4) acquired in step S2. The Holt-Winsters method, ARIMA method, SARIMA method, Gaussian process regression, or Prophet can be used for applying a general time series model to the performance index data. FIG. 5 is a graph showing an example of the overall performance function F(t) thus obtained for the turbine internal efficiency data acquired in step S2.

Then, the individual performance function definition part 24 defines a plurality of individual performance functions each of which indicates a change (e.g., performance degradation) over time in performance index caused by a plurality of change factors of the performance index (here, turbine internal efficiency), respectively (S6).

The plurality of change factors of the performance index are assumed in advance. The performance degradation factors of the turbine 2 include, for example, increased clearance between turbine blades and casing, deterioration of surface roughness of turbine blade surfaces, increased erosion of turbine blades, increased leakage of working fluid (e.g., steam), and decreased flow path cross-sectional area due to scale deposition, etc.

In this embodiment, as the factors that degrade the performance of the turbine internal efficiency, four factors are set: increased clearance between turbine blades and casing (hereinafter referred to as “clearance”), deterioration of surface roughness of turbine blade surfaces (hereinafter referred to as “blade roughness”), degree of erosion of turbine blades (hereinafter referred to as “erosion”), and another factor (hereinafter referred to as “other factor”). The individual performance function which indicates performance degradation due to clearance is denoted as A(t), the individual performance function which indicates performance degradation due to clearance as B(t), the individual performance function which indicates performance degradation due to erosion as C(t), and the individual performance function which indicates performance degradation due to the other factor as etc(t).

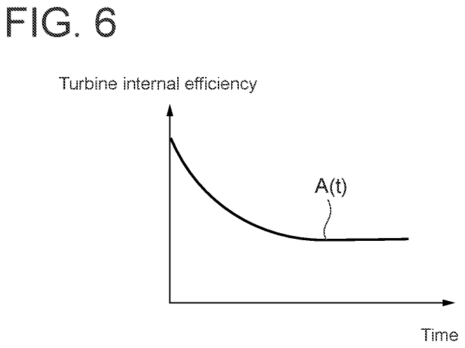

With reference to FIGS. 6 and 10, the way of defining the individual performance functions according to some embodiments will be described. As an example, the following describes how to define the individual performance function A(t), which indicates a change (performance degradation) in performance over time due to increased clearance as the performance degradation factor.

In some embodiments, in step S6, the individual performance function is defined for the change factor of the performance index (performance degradation factor; in this case, increased clearance) on the basis of theoretical or measured values of a parameter (e.g., clearance value) related to the change factor. FIG. 6 is a schematic graph showing an example of the individual performance function A(t) obtained in step S6 for change (performance degradation) in turbine internal efficiency (performance index) due to increased clearance (performance degradation factor).

More specifically, in step S6, the individual performance function is defined based on a first correlation between the value of the above-described parameter and the magnitude of performance change of the evaluation target device, and a second correlation between the value of the above-described parameter and the time. The first correlation and second correlation can be obtained, for example, by the procedure described below. In step S6, the first correlation and second correlation thus obtained are combined to obtain the individual performance function which indicates a change (performance degradation) over time in performance index for the parameter. The first correlation and second correlation may be stored in the storage part 14 in advance.

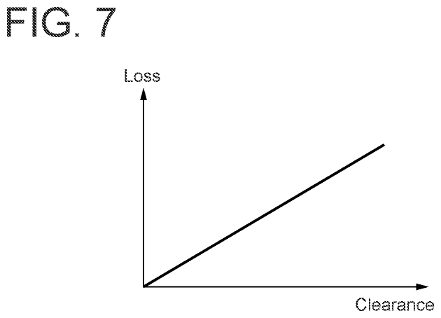

Here, FIG. 7 is a diagram schematically showing an example of the first correlation. The first correlation shown in FIG. 7 is the correlation between the clearance value (horizontal axis) as the parameter value and the loss (vertical axis) as the magnitude of performance change. Specifically, the graph of FIG. 7 is a curve showing the increase in loss with increase in clearance (loss increase curve). The first correlation can be obtained from design data (theoretical value), for example.

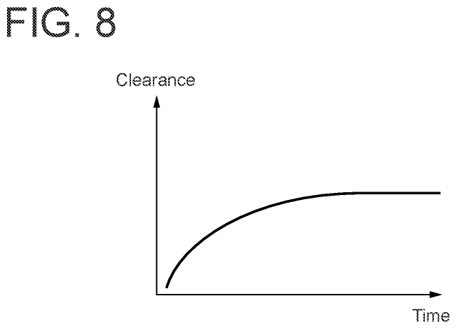

FIG. 8 is a diagram schematically showing an example of the second correlation. The second correlation shown in FIG. 8 is the correlation between the clearance value (vertical axis) as the parameter value and the time (horizontal axis). Specifically, the graph of FIG. 8 is a curve showing the change (increase) in clearance over time (physical quantity temporal change curve).

The second correlation can be obtained based on measured values of the evaluation target device or based on a literature survey. For example, in an embodiment, the second correlation is acquired by fitting a base curve having the shape of the correlation between the parameter value and the time to measured values of the parameter (clearance, etc.). A curve of a general function (exponential function, etc.) can be used as the base curve.

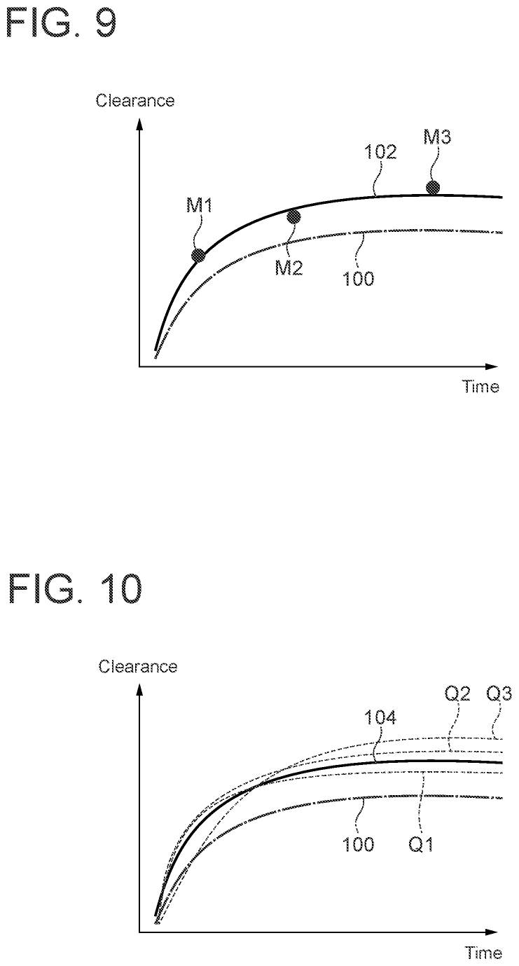

FIGS. 8 and 9 are each a diagram for describing an example of how to obtain the second correlation.

In the example shown in FIG. 9, the second correlation 102 is acquired by fitting a base curve 100 to measured values M1 to M3 of the parameter (clearance in this case) of the evaluation target device (turbine 2). The measured values M1 to M3 of the parameter of the evaluation target device can be acquired, for example, during periodic inspections. Fitting of the base curve 100 to the measured values M1 to M3 may be performed by determining the coefficient of the function expressing the base curve so that the sum of the distances between the measured values M1 to M3 and the second correlation 102 based on the base curve 100 is minimized (i.e., by the least square method).

In the example shown in FIG. 10, curves (e.g., Q1 to Q3) representing the relationship between measured values of the parameter (clearance) and the time in multiple plants (other plants similar to the plant containing the evaluation target device) are acquired. These curves (Q1 to Q3) may be acquired by the method described with reference to FIG. 9. Further, fitting of the base curve 100 and the curves Q1 to Q3 based on the measured values may be performed by determining the coefficient of the function expressing the base curve so that the curve of the second correlation 104 based on the base curve 100 is an approximation of these curves (Q1 to Q3).

The measured values (e.g., P1 to P3) of the parameter and the curves (Q1 to Q3) based on the measured values may be stored in the storage part 14 in advance.

Through the procedure described above, the individual performance functions A(t), B(t), C(t), and etc(t) can be defined, which indicate the performance degradation caused by the plurality of performance degradation factors (clearance, blade roughness, erosion, and other factor) respectively.

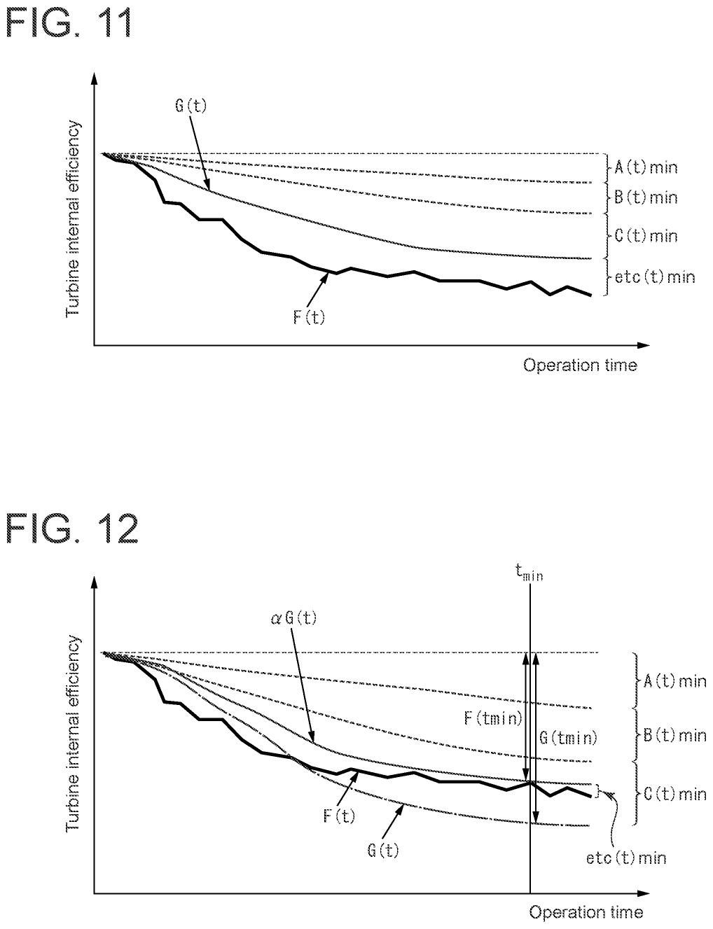

The individual performance function etc(t) corresponding to the other factor may be defined as follows, under the assumption that the other individual performance functions A(t), B(t) and C(t) have already been obtained. FIGS. 11 and 12 are each a schematic graph visually showing an example of the performance estimation model. In FIGS. 11 and 12, F(t) represents the overall performance function acquired in step S4, and G(t) represents the sum of the individual performance functions A(t), B(t) and C(t) (i.e., G(t)=A(t)+B(t)+C(t)).

As shown in FIG. 11, when the minimum value of (F(t)−G(t)) is equal to or greater than zero (min(F(t)−G(t))≥0) at all times, the individual performance function etc(t) can be defined as the difference between F(t) and G(t) (the following equation (B)).

etc(t)=F(t)−G(t) (B)

On the other hand, as shown in FIG. 12, when there is a time when the minimum value of (F(t)−G(t)) is smaller than zero (min(F(t)−G(t))<0), the individual performance function etc(t) can be defined by the following equation (C).

etc(t)=F(t)−α*G(t) (C)

In the equation (C), a is the ratio of F(t) to G(t) when (F(t)−G(t)) is minimum (t=tₘᵢₙ). That is, α can be expressed by the following equation (D).

α=F(tₘᵢₙ)/G(tₘᵢₙ) (D)

Then, the model generation part 26 generates a performance estimation model for the turbine 2 (evaluation target device) by performing superposition of the plurality of individual performance functions A(t), B(t), C(t), and etc(t) defined in step S6 (S8).

The superposition of the plurality of individual performance functions in step S8 may be performed using a statistical superposition method. As the statistical superposition method, a generalized linear model or a generalized additive model can be used.

The performance estimation model can be expressed as a linear combination of the plurality of individual performance functions by the following equation (A), for example. In the equation (A), n1 to n4 represent the coefficients of the plurality of individual performance functions (A(t), B(t), C(t), etc(t)).

F′(t)=n1*A(t)+n2*B(t)+n3*C(t)+n4*etc(t) (A)

In the above-described step S8, the model generation part 26 determines the coefficient (e.g., coefficients n1 to n4 in the equation (A)) of each of the plurality of individual performance functions in the superposition so that the superposition of the plurality of individual performance functions becomes close to the overall performance function.

The determination of the coefficient of each of the individual performance functions in step S8 may be performed using multiple regression analysis, Bayesian estimation, or neural networks (LSTM (Longshort-termmemory), etc.).

Then, on the basis of the performance estimation model generated in step S8, the performance degradation of the turbine 2 (evaluation target device) is quantitatively estimated, or the performance degradation factors are estimated (S10). From the performance estimation model, the trend of performance degradation based on each of the performance degradation factors and the contribution of each factor to the overall performance degradation trend can be determined. On the basis of this, the performance degradation of the turbine 2 (evaluation target device) can be quantitatively estimated, or the performance degradation factors can be estimated.

According to the above embodiment, coefficients (n1 to n4) in the superposition of the individual performance functions (A(t), B(t), C(t), etc(t)) indicating performance changes caused by respective change factors (performance change factors) of the performance index are determined so as to approximate the overall performance function (F(t)) indicating a change over time in performance index (e.g., turbine internal efficiency) of the turbine 2 (evaluation target device) (i.e., weighting). Thus, the performance estimation model (F′(t)) including the weight of each of the performance change factors can be generated. Therefore, it is possible to quantitatively estimate changes over time in performance and estimate the factors behind the performance changes for the turbine 2 (evaluation target device).

Further, as described above, in step S6, the individual performance function may be determined for each of the performance change factors on the basis of theoretical or measured values of parameters related to the change factors. In this case, the accuracy of performance change estimation of the evaluation target device is improved.

Further, as described above, in step S6, the individual performance function may be determined based on the first correlation between the value of the parameter related to the performance change factor and the magnitude of performance change, and the second correlation between the value of the parameter and the time. Thus, the individual performance function can be defined appropriately for each performance change factor. As a result, the accuracy of performance change estimation of the evaluation target device is further improved.

As described above, in step S6, the second correlation may be acquired by fitting a base curve having a predetermined shape to measured values of the parameter related to the performance change factor. Thus, the second correlation in line with measured values can be acquired. Therefore, it is possible to accurately estimate the performance change factors of the evaluation target device.

In some embodiments, in the above-described step S8, the model generation part 26 may determine the coefficient (n1 to n4) of each of the plurality of individual performance functions (A(t), B(t), C(t), etc(t)) by using the Bayesian inference method.

Here is a brief description of the procedure for determining the coefficients n1 to n4 in the performance estimation model y=F′(t)=n1*A(t)+n2*B(t)+n3*C(t)+n4*etc(t) using the Bayesian inference method.

(a) First, a prior distribution (range, shape, etc.) of the linear parameters (coefficients) N=(n1, n2, n3, n4) of the performance estimation model y=F′(t) is set based on empirical rules. Here, if prior information is scarce, a conjugate prior distribution or uniform distribution may be used as the prior distribution.

(b) A likelihood function which indicates the degree of agreement with data Y=F(t) is calculated by variously changing linear parameters N=(n1, n2, n3, n4) of the performance estimation model Y=F′(t). The likelihood function is calculated as the product of the probabilities P(F(t)|F′(t), N) determined by the deviation of observed data Y=F(t) of each sample from the y-coordinate corresponding to the t-coordinate of the sample on the curve (y=F′(t)) for the linear parameter N in the current calculation step (i.e., P(F(t₁)|F′(t₁), N)*P(F(t₂)|F′(t₂), N)* . . . *P(F(tₖ)|F′(tₖ), N)). The calculated values are organized on the horizontal axis n1 to n4, respectively, to obtain the likelihood P(Y|N).

(c) For each of the linear parameters n1 to n4, random sampling is performed using a random number generation algorithm based on the prior distribution. For example, the Markov chain Monte Carlo method (MCMC method) can be used as the random number generation algorithm. In the MCMC method, the Hamiltonian Monte Carlo method, Gibbs sampler, or Metropolis method can be used as the algorithm for generating MCMC samples.

(d) The likelihood is calculated from the above (b) for each sampling point of the linear parameters n1 to n4 sampled in the above (c).

(e) For each of the linear parameters n1 to n4, probability density distribution P(Y|N)P(N) is obtained from the product of the prior distribution and the likelihood.

(f) For each of the linear parameters n1 to n4, the probability density distribution P(Y|N)P(N) obtained in the above (e) is divided (normalized) by its area to obtain posterior distribution P(Y|N) such that the area is 1.

(g) For each of the linear parameters n1 to n4, the expected value of the posterior distribution P(Y|N) is the estimated value of the linear parameter.

In the above-described embodiment, since a probabilistic model based on the concept of Bayesian inference is used in determining the coefficients (n1 to n4) in the superposition of the individual performance functions (A(t), B(t), C(t), etc(t)) indicating performance changes caused by respective performance change factors, the model can reflect the subjective information of the model creator. Thus, the accuracy of performance change estimation of the evaluation target device is improved. The use of the Bayesian inference also has the effect of making the system more resistant to outliers.

Further, by using the random number generation algorithm in determining the posterior distribution of each coefficient in the Bayesian inference, the posterior distribution of the Bayesian inference can be obtained by a computer.

Further, by determining the range or shape of the prior distribution of the coefficients n1 to n4 in the Bayesian inference on the basis of data previously acquired or physical assumptions, physical assumptions and empirical rules can be reflected in the prior distribution in the Bayesian inference. Therefore, even when there is little data for determining the individual performance function for each performance change factor, it is possible to improve the accuracy of performance change estimation of the evaluation target device.

The contents described in the above embodiments would be understood as follows, for instance.

(1) An apparatus (20) for evaluating performance of a device according to at least one embodiment of the present invention includes: an overall performance function acquisition part (22) configured to obtain an overall performance function (e.g., the above-described F(t)) which indicates a change over time in performance index of an evaluation target device, on the basis of data acquired during operation of the evaluation target device (e.g., the above-described turbine 2); an individual performance function definition part (24) configured to define a plurality of individual performance functions (e.g., the above-described A(t), B(t), C(t), etc(t)) each of which indicates a change over time in the performance index caused by a plurality of change factors of the performance index, respectively; and a model generation part (26) configured to generate a performance estimation model (e.g., the above-described F′(t)) for the evaluation target device by performing superposition of the plurality of individual performance functions. The model generation part is configured to determine a coefficient (e.g., the above-described n1 to n4) of each of the plurality of individual performance functions in the superposition so that the superposition of the plurality of individual performance functions becomes close to the overall performance function.

With the above configuration (1), coefficients in the superposition of the individual performance functions indicating performance changes caused by respective change factors (performance change factors) of the performance index are determined so as to approximate the overall performance function indicating a change over time in performance index of the evaluation target device (i.e., weighting). Thus, the performance estimation model including the weight of each of the performance change factors can be generated. Therefore, it is possible to quantitatively estimate changes over time in performance and estimate the factors behind the performance changes for the evaluation target device.

(2) In some embodiments, in the above configuration (1), the model generation part is configured to determine the coefficient of each of the plurality of individual performance functions by using a Bayesian inference method.

With the above configuration (2), since a probabilistic model based on the concept of Bayesian inference is used in determining the coefficients in the superposition of the individual performance functions indicating performance changes caused by respective performance change factors, the model can reflect the subjective information of the model creator, and the accuracy of performance change estimation of the evaluation target device is improved.

(3) In some embodiments, in the above configuration (2), the model generation part is configured to obtain a posterior distribution of the coefficient in the Bayesian inference using a random number generation algorithm.

With the above configuration (3), by using the random number generation algorithm in determining the posterior distribution of each coefficient in the Bayesian inference, the posterior distribution of the Bayesian inference can be obtained by a computer.

(4) In some embodiments, in the above configuration (2) or (3), the model generation part is configured to determine a range or a shape of a prior distribution of the coefficient in the Bayesian inference, on the basis of data previously acquired or physical assumptions.

With the above configuration (4), physical assumptions and empirical rules can be reflected in the prior distribution in the Bayesian inference. Therefore, even when there is little data for determining the individual performance function for each performance change factor, it is possible to improve the accuracy of performance change estimation of the evaluation target device.

(5) In some embodiments, in any one of the above configurations (1) to (4), the individual performance function definition part is configured to define the individual performance function, for each of the plurality of change factors, on the basis of a theoretical value or a measured value of a parameter related to the change factor.

With the above configuration (5), the individual performance function can be determined for each of the performance change factors on the basis of theoretical or measured values of parameters related to the change factors. As a result, the accuracy of performance change estimation of the evaluation target device is improved.

(6) In some embodiments, in the above configuration (5), the individual performance function definition part is configured to define the individual performance function, on the basis of a first correlation between a value of the parameter and a magnitude of performance change of the evaluation target device, and a second correlation between a value of the parameter and a time.

With the above configuration (6), the individual performance function is determined based on the first correlation between the value of the parameter related to the performance change factor and the magnitude of performance change, and the second correlation between the value of the parameter and the time. Therefore, the individual performance function can be defined appropriately for each performance change factor, so that the accuracy of performance change estimation of the evaluation target device is further improved.

(7) In some embodiments, in the above configuration (6), the individual performance function definition part is configured to acquire the second correlation by fitting a base curve having a shape of a correlation between a value of the parameter and a time to a measured value of the parameter.

With the above configuration (7), since the base curve having a predetermined shape is fitted to measured values of the parameter related to the performance change factor, the second correlation in line with measured values can be acquired. Therefore, it is possible to accurately estimate the performance change factors of the evaluation target device.

(8) A method for evaluating performance of a device according to at least one embodiment of the present invention includes: a step (S4) of obtaining an overall performance function which indicates a change over time in performance index of an evaluation target device, on the basis of data acquired during operation of the evaluation target device; a step (S6) of defining a plurality of individual performance functions each of which indicates a change over time in the performance index caused by a plurality of change factors of the performance index, respectively; and a step (S8) of generating a performance estimation model for the evaluation target device by performing superposition of the plurality of individual performance functions. The step of generating the performance estimation model includes determining a coefficient of each of the plurality of individual performance functions in the superposition so that the superposition of the plurality of individual performance functions becomes close to the overall performance function.

With the above method (8), coefficients in the superposition of the individual performance functions indicating performance changes caused by respective change factors (performance change factors) of the performance index are determined so as to approximate the overall performance function indicating a change over time in performance index of the evaluation target device (i.e., weighting). Thus, the performance estimation model including the weight of each of the performance change factors can be generated. Therefore, it is possible to quantitatively estimate changes over time in performance and estimate the factors behind the performance changes for the evaluation target device.

(9) A program for evaluating performance of a device according to at least one embodiment of the present invention is configured to cause a computer to execute: a process of obtaining an overall performance function which indicates a change over time in performance index of an evaluation target device, on the basis of data acquired during operation of the evaluation target device; a process of defining a plurality of individual performance functions each of which indicates a change over time in the performance index caused by a plurality of change factors of the performance index, respectively; and a process of generating a performance estimation model for the evaluation target device by performing superposition of the plurality of individual performance functions. The process of generating the performance estimation model includes determining a coefficient of each of the plurality of individual performance functions in the superposition so that the superposition of the plurality of individual performance functions becomes close to the overall performance function.

With the above program (9), coefficients in the superposition of the individual performance functions indicating performance changes caused by respective change factors (performance change factors) of the performance index are determined so as to approximate the overall performance function indicating a change over time in performance index of the evaluation target device (i.e., weighting). Thus, the performance estimation model including the weight of each of the performance change factors can be generated. Therefore, it is possible to quantitatively estimate changes over time in performance and estimate the factors behind the performance changes for the evaluation target device.

Embodiments of the present invention were described in detail above, but the present invention is not limited thereto, and various amendments and modifications may be implemented.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, and “have” are not intended to be exclusive of other components.

### REFERENCE SIGNS LIST

2 Turbine
2a Upstream stage section
2b Downstream stage section
12 Measurement part
14 Storage part
16 Display part
20 Performance evaluation apparatus
22 Overall performance function acquisition part
24 Individual performance function definition part
26 Model generation part
28 Evaluation part
100 Base curve
102 Second correlation
104 Second correlation

1. An apparatus for evaluating performance of a device, comprising:
an overall performance function acquisition part configured to obtain an overall performance function which indicates a change over time in performance index of an evaluation target device, on the basis of data acquired during operation of the evaluation target device;
an individual performance function definition part configured to define a plurality of individual performance functions each of which indicates a change over time in the performance index caused by a plurality of change factors of the performance index, respectively; and
a model generation part configured to generate a performance estimation model for the evaluation target device by performing superposition of the plurality of individual performance functions,
wherein the model generation part is configured to determine a coefficient of each of the plurality of individual performance functions in the superposition so that the superposition of the plurality of individual performance functions becomes close to the overall performance function.

2. The apparatus for evaluating performance of a device according to claim 1,
wherein the model generation part is configured to determine the coefficient of each of the plurality of individual performance functions by using a Bayesian inference method.

3. The apparatus for evaluating performance of a device according to claim 2,
wherein the model generation part is configured to obtain a posterior distribution of the coefficient in the Bayesian inference using a random number generation algorithm.

4. The apparatus for evaluating performance of a device according to claim 2,
wherein the model generation part is configured to determine a range or a shape of a prior distribution of the coefficient in the Bayesian inference, on the basis of data previously acquired or physical assumptions.

5. The apparatus for evaluating performance of a device according to claim 1,
wherein the individual performance function definition part is configured to define the individual performance function, for each of the plurality of change factors, on the basis of a theoretical value or a measured value of a parameter related to the change factor.

6. The apparatus for evaluating performance of a device according to claim 5,
wherein the individual performance function definition part is configured to define the individual performance function, on the basis of a first correlation between a value of the parameter and a magnitude of performance change of the evaluation target device, and a second correlation between a value of the parameter and a time.

7. The apparatus for evaluating performance of a device according to claim 6,
wherein the individual performance function definition part is configured to acquire the second correlation by fitting a base curve having a shape of a correlation between a value of the parameter and a time to a measured value of the parameter.

8. A method for evaluating performance of a device, comprising:
a step of obtaining an overall performance function which indicates a change over time in performance index of an evaluation target device, on the basis of data acquired during operation of the evaluation target device;
a step of defining a plurality of individual performance functions each of which indicates a change over time in the performance index caused by a plurality of change factors of the performance index, respectively; and
a step of generating a performance estimation model for the evaluation target device by performing superposition of the plurality of individual performance functions,
wherein the step of generating the performance estimation model includes determining a coefficient of each of the plurality of individual performance functions in the superposition so that the superposition of the plurality of individual performance functions becomes close to the overall performance function.

9. A computer-readable storage medium that stores a program for evaluating performance of a device configured to cause a computer to execute:
a process of obtaining an overall performance function which indicates a change over time in performance index of an evaluation target device, on the basis of data acquired during operation of the evaluation target device;
a process of defining a plurality of individual performance functions each of which indicates a change over time in the performance index caused by a plurality of change factors of the performance index, respectively; and
a process of generating a performance estimation model for the evaluation target device by performing superposition of the plurality of individual performance functions,
wherein the process of generating the performance estimation model includes determining a coefficient of each of the plurality of individual performance functions in the superposition so that the superposition of the plurality of individual performance functions becomes close to the overall performance function.
